(19) United States
(12) Patent Application Publication
(10) Pub. No.: US 2005/0141851 A1
(43) Pub. Date: Jun. 30, 2005

(54) Display apparatus

(75) Inventors: Yoshiaki Nakayama, Chigasaki-shi (JP); Nobuaki Kabuto, Kunitachi-shi (JP); Yohei Kato, Chigasaki-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/920,949

(22) Filed: Aug. 18, 2004

(30) Foreign Application Priority Data
Dec. 26, 2003 (JP) 2003-432015

(51) Int. Cl. H04N 5/76; H04N 5/781; G09G 3/36

(52) U.S. Cl. 386/46; 386/125

(57) ABSTRACT

A display apparatus includes a memory circuit for storing information regarding the display apparatus, a read enable unit for allowing an external device to read information from the memory circuit, and a write disable unit for inhibiting a write operation in the memory circuit when either one of the power sources of the display apparatus and the external device turns on, allowing the write operation in the memory circuit in response to a signal from an external terminal used by the read enable unit.

### INCORPORATION BY REFERENCE

The present application claims priority from Japanese application JP 2003-432015 filed on Dec. 26, 2003, the content of which is hereby incorporated by reference into this application.

### BACKGROUND OF THE INVENTION

The present invention relates to a display apparatus communicable with a video signal source connected thereto such as a set-top box (STB), digital versatile disk (DVD) player, audiovisual (AV) receiver, or a personal computer (PC).

These apparatuses are connected to the display apparatus via a display interface conforming to a predetermined standard. The video signal source apparatus reads via the display interface information of specifications including, for example, information of a maker of the device, information of a type thereof, and an associated signal frequency of the display beforehand stored in an integrated memory such as a nonvolatile memory, e.g., an electrically erasable programmable read only memory (EEPROM) of the display apparatus. According to the obtained information of specifications, the video signal source apparatus supplies, for example, an optimal video signal suitable for the display apparatus to the display apparatus. Display systems of this kind are constructed according to a standard called “display date channel (DDC) standard”. Recently, there have been increasingly and broadly utilized such products coping with a display system achieving a plug-and-play operation according to the DDC standard.

The display interface standards include a D-sub pin connector interface for analog video signals and a digital visual interface (DVI) and a high-definition digital multimedia interface (HDMI) for digital video signals.

For example, JP-A-11-15457 describes a technique associated with the D-sub pin-connector interface. The information of specifications of the display apparatus is written in a nonvolatile memory of the display apparatus, for example, when the display apparatus is delivered from a factory or firm thereof. To prevent the contents of the memory from being rewritten or changed by, for example, an operation of a user, the display apparatus includes an erroneous rewriting inhibiting circuit. The inhibiting circuit is described in, for example, JP-A-11-344962.

According to, for example, FIG. 4 of JP-A-11-344962, a power source of the memory includes a diode-OR-connection of a power source in the display apparatus and a power source (of about +5 volt) of a personal computer. There is also shown a configuration in which the inhibiting circuit supervises, according to presence or absence of a power source voltage of about +5 volt from a personal computer, a control terminal to disable or to enable a memory write operation in the memory in which the specifications of the display apparatus have been written.

In the erroneous rewriting inhibiting circuit of JP-A-11-344962, when a voltage of about +5 volt is supplied from both of the power supply in the display apparatus and that of the personal computer, the memory write disable/enable control terminal is set to an “L” level to inhibit the memory write operation. However, when the memory is powered by the power source in the display apparatus and is not supplied with a voltage of about +5 volt from the personal computer, the memory write disable/enable control terminal is set to an “H” level allowing the memory write operation.

In this situation, since various makers produce various personal computers to be connected to the display apparatus, there exists a fear that the specification information of the display apparatus is rewritten or changed depending on personal computers connected thereto.

The erroneous rewriting inhibiting circuit of JP-A-11-344962 does not also conform to DVI and HDMI.

According to the interfaces, when the specification information is read from the memory of the display apparatus, the video signal supply first feeds a voltage of about +5 volt to the display apparatus and thereafter it is detected that a signal at an “H” level is returned to its hot plug detect signal (HPD) terminal from the display apparatus. The return signal will be accordingly referred to as “HPD signal” or “read enable signal”, and a line to pass the return signal will be referred to as “HPD line” or “read enable signal line” hereinbelow.

For example, at shipping of the display apparatus from a factory, since it is actually required in some cases to rewrite the contents of the display apparatus, it is not sufficient that the rewriting inhibiting circuit is implemented only to inhibit the rewriting operation in the memory. Therefore, it is quite important how to carry out a normal rewriting operation other than any erroneous rewriting operation.

### SUMMARY OF THE INVENTION

It is therefore an object of the present invention, which has been device to remove the problem, to provide a display apparatus having higher reliability.

A second object of the present invention is to provide a display apparatus having higher usability.

To achieve the first object in accordance with the present invention, in a memory having stored specification information of a display apparatus, even when the memory is powered by at least either one of a power source of a video signal source apparatus or a power source incorporated in the display apparatus, the memory is not set to a write enabled state allowing a write operation in the memory.

Specifically, as described in the scope of claims, there is provided a display apparatus for displaying video information from an external device. The display apparatus includes a memory circuit for storing information regarding the display apparatus, a read enable unit for allowing the external device to read information from the memory circuit, a write disable unit for inhibiting a write operation in the memory circuit when either one of a power supply of the display apparatus or a power supply of the external device turns on, and a write enable unit for allowing a write operation in the memory circuit in response to a signal from an external terminal used by the read enable unit.

As a result, even when the power source of the display apparatus or that of the external device such as a personal computer turns on, the memory write operation is kept inhibited. This increases reliability for the erroneous or wrong rewriting operation in the memory. That is, so far as the display apparatus or the external device operates in an ordinary way, the writing operation can be inhibited. On the other hand, to conduct an ordinary or required write operation, a device such as a particular dedicated device is connected to the display apparatus such that the read enable signal line is controlled as a read enable signal from the dedicated device to thereby control whether or not the write operation is enabled. It is therefor possible that the contents of the memory can be rewritten in a firm or factory producing the display apparatus when required, and hence usability of the display apparatus is improved.

To achieve the second object in accordance with the present invention, the display apparatus is configured to conform to display interfaces such as DVI and HDMI so that the write disable/enable control terminal of the memory is controlled by use of the HPD line to resultantly increase usability of the display apparatus.

Specifically, as described in the scope of claims, there is provided a display apparatus for displaying an image of video information from an external device. The display apparatus includes a memory circuit for storing information regarding the display apparatus, a read enable unit for allowing the external device to read information from the memory circuit, and a write enable unit for allowing a write operation in the memory circuit in response to a signal from an external terminal used by the read enable unit.

These interfaces, i.e., DVI and HDMI do not include a dedicated terminal to control allowance or inhibition of the memory write operation. Therefore, if the control operation is conducted such that the memory is set to the write disabled or inhibited state when the memory is powered by either one of the power source or the video signal source apparatus and that disposed in the display apparatus as above, control of allowance of the memory writing operation becomes quite important. In accordance with the present invention, the display apparatus is configured such that the read enable signal line and the +5V power line are used among the terminals employed in DVI and HDMI to thereby increase usability of the display apparatus. However, the present invention is not limited to DVI and HDMI. Any interfaces having similar functions to those of DVI and HDMI may also be used.

As above, in accordance with the present invention, for example, by connecting a particular dedicated device for the display production line and the display maintenance to the display apparatus and by controlling the read enable signal line or the +5 V power line for memory as a write disable/enable signal from the dedicated device, the write disable/enable operation is controlled.

Although not removing the fear of the erroneous rewriting inhibiting circuit described above, it is possible in FIG. 4 of JP-A-11-344962 that a resistor is arranged between the +5 V power line from the personal computer and the HPD line to the personal computer to return the +5 V power via the resistor to the HPD terminal on the display apparatus side to thereby cope with the standard of DVI and HDMI.

In accordance with one aspect of the present invention, reliability of the display apparatus is improved. In accordance with another aspect of the present invention, usability of the display apparatus is improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an embodiment of a display apparatus in accordance with the present invention; and

FIG. 2 is a block diagram showing an embodiment of an erroneous rewriting inhibiting circuit and a write disable/enable control block in the embodiment of FIG. 1.

### DESCRIPTION OF THE EMBODIMENTS

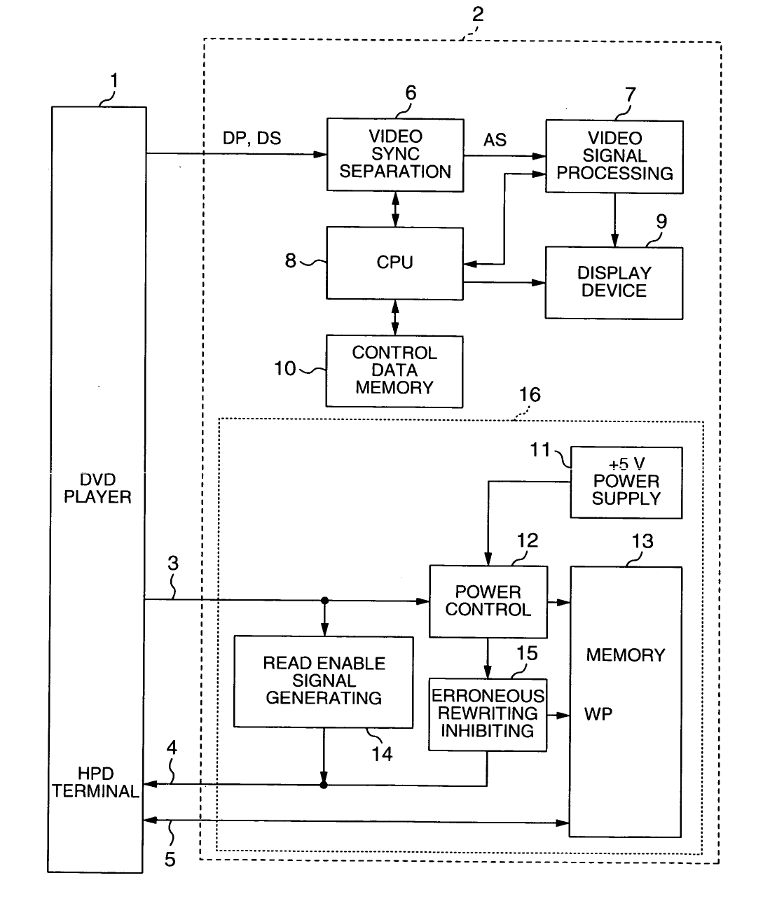

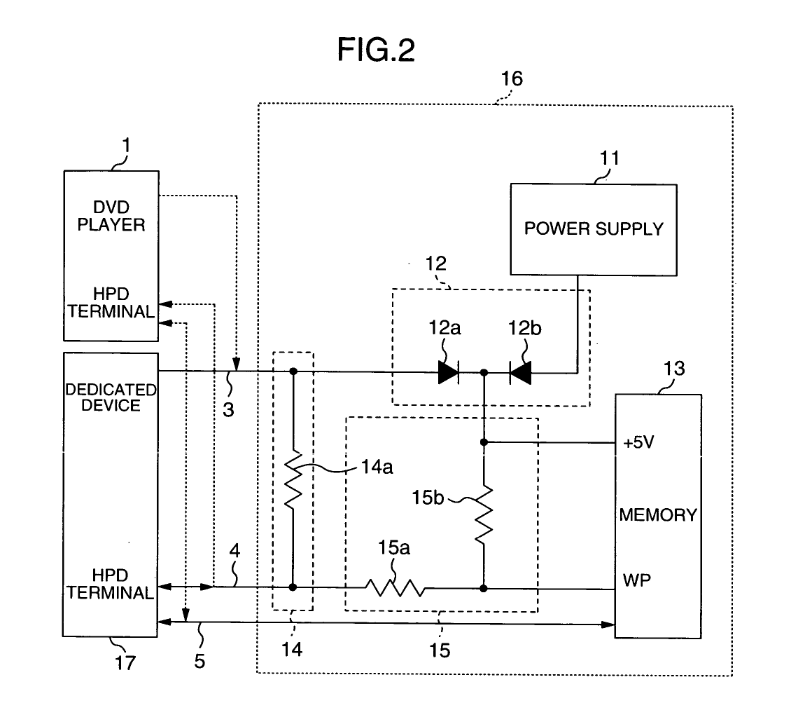

Referring now to the drawings, description will be given in detail of an embodiment according to the present invention. In FIGS. 1 and 2, the constituent components having the same functions are assigned with the same reference numerals.

FIG. 1 is a block diagram showing an embodiment of a display apparatus according to the present invention. The embodiment includes a DVD player 1 as a video signal source apparatus, a display apparatus 2 of this embodiment, a +5 V power line 3 to supply +5 V power from the DVD player 1, a memory read enable signal line (HPD) line 4, a communication interface 5 between the DVD player 1 and a memory, which will be described later; a video sync separation block 6, a video signal processing circuit 7, a central processing unit (CPU) 8, a display device 9, a control data memory 10, a +5 V power supply 11, a power control circuit 12 including an OR connection of +5 V power from the +5 V power line 3 and +5 V power from the +5 V power source 11 using a directional element, a memory 13 having stored information of specifications of the display apparatus 2, a read enable signal generating block 14 to output an H-level signal to the read enable signal line (HPD) line 4 when +5 volt is supplied to the +5 V power line 3, an erroneous rewriting inhibiting block 15, and a write disable/enable control block 16. This embodiment adopts a display interface of DVI or HDMI and hence includes the read enable signal generating block 14.

In the circuit of FIG. 1, the DVD player 1 supplies a video signal DP including R, G, and B components and a sync signal DS to the display apparatus 2. Using these signals, the video sync separating circuit 6 produces an analog video signal AS with the sync signal superimposed thereon and feeds the signal AS to the video signal processing circuit 7.

The CPU 8 receives a signal from the video sync separation circuit 6 to identify an input signal format according to information of the signal and reads control data such as amplitude and color space from the control data memory 10 to control the video signal processing circuit 7.

Although the control data memory 10 and the CPU 8 are arranged as units separated from each other in the configuration, the present invention is not restricted by this embodiment. For example, a read only memory (ROM) integrated in the CPU may be used as the control data memory 10.

For the video signal AS delivered from the video sync separating circuit 6, the video signal processing circuit 7 conducts signal processing such as amplification and level shift according to the control information outputted from the CPU 8 and delivers the resultant signal to the display device 9.

Through the operations of the respective components, an image such as a video image and a character associated with the video signal DS are displayed on the display device 9. The display device 9 may be any device capable of displaying a video image and a character such as a device of cathode-ray tube (CRT) type, liquid-crystal type, or plasma type.

The memory 13 is a rewritable device having recorded information of specifications of the display apparatus 2 such as a maker thereof, a type thereof, and an associated signal frequency. According to the plug-and-play operation between the DVD player 1 and the display apparatus 2, part or all of the recorded information can be sent via the communication interface 5 to the DVD player 1. The interface 5 is a serial transmission interface conforming to DVI or HDMI.

As a result of operations of the respective constituent components, the DVD player 1 produces the video signal DP and the sync signal DS with maximum resolution for the operation of the display apparatus 2. That is, without imposing any trouble on the user, it is possible to automatically display an image under an optimal condition. The plug-and-play operation can be conducted not only by the DVD player 1 but also by a personal computer, a set-top box, and an AV receiver in a similar way.

The display apparatus 2 further includes an erroneous rewriting inhibiting circuit 15 to prevent the DVD player 1 from erroneously rewrites data in the memory 13. Next, description will be given of embodiments according to the present invention.

### First Embodiment

FIG. 2 is a block diagram showing a first embodiment of an erroneous rewriting inhibiting circuit 15 and its peripheral circuit, i.e., a write disable/enable control circuit 16 according to the present invention. The configuration includes directive elements, i.e., diodes 12a and 12b to establish an OR connection between the +5 V power source from the +5 V power line 3 and the +5 V power source in the display apparatus 2; resistors 14a, 15a, and 15b; and a particular dedicated unit 17 connected in place of the DVD player 1 when the specification information of the display apparatus 2 is written in the memory 13. The resistance values of resistors 15a and 15b are sufficiently larger than that of the resistor 14a. In FIG. 2, the same constituent components as those of FIG. 1 are assigned with the same reference numerals.

The memory 13 is a type of storage device including a control terminal WP to disable/enable a writing operation in an memory array thereof. The control specification of the control terminal WP of the memory 13 varies depending on the type of the memory 13. It is assumed in this case that an ordinary control specification is used, that is, the writing operation is inhibited when the terminal WP is at an “H” level and the write operation is allowed when the terminal WP is at an “L” level. The write disable voltage has a lower-limit value of V_{IH} and the write enable voltage has a maximum value of V_{IL}, each of the diodes 12a and 12b has a voltage drop of VF, and the read enable signal line (HPD line) 4 is at a voltage of V_{HPD}.

When the DVD player 1 as the video signal source device reads the specification information of the display apparatus 2 from the memory 13 according to the related technique, the +5 voltage supplied from the video signal source side via the +5 V power line 3 to the display apparatus 2 appears via the resistor 14a of the read enable signal generator 14 on the read enable signal (HPD) line 4 and is returned to the HPD terminal of the DVD player 1. Although the particular dedicated unit 17 and the DVD player 1 are connected to the write disable/enable control block 16 in FIG. 2, it is not required to connect the dedicated unit 17 to the control block 16 in the read operation.

To write the specification information in the memory 13, the display interface standard does not particularly stipulate any rules for the read enable signal (HPD) line 4. Therefore, the line 4 has not been used in the conventional technique.

In this embodiment, in the operation to write the specification information in the memory 13, the read enable signal (HPD) line 4 is supplied with a predetermined voltage to resultantly set the memory 13 to a write enabled state. The predetermined voltage is independent of the +5 V power source voltage supplied from the video signal source to the display apparatus 2. In the embodiment, to write the specification information in the memory 13, the video signal source is not used, but the dedicated unit 17 which is a writing jig is used. It is required that the dedicated unit 17 is a device to which the independent predetermined voltage can be applied via the read enable signal (HPD) line 4 and which can write data in the memory 13. Although the particular dedicated unit 17 and the DVD player 1 are connected to the write disable/enable control block 16 in FIG. 2, it is not required to connect the dedicated unit 17 to the control block 16 in the rewriting operation.

Description will now be given of the control specification of the control terminal WP of the memory 13, that is, the condition to control operation to allow or to inhibit a memory writing operation in the memory 13.

It is essential that since various video signal sources are connected to the display apparatus 2, even when the +5 V power source voltage is not supplied from the video signal source side, the memory 13 is not set to the write enabled state. Assume that when the memory 13 is powered by the +5 V power source 11, the +5 V power line 3 of the dedicated unit 17 is open, and the voltage of the read enable signal (HPD) line 4 is V_{HPD}, the values of V_{IH}, V_{IL}, and the resistors 14a, 15a, and 15b are set to satisfy the following write disable condition as below.
V_{IH}<(5−V_{F})×15a÷(15a+15b)+V_{HPD} (1)
wherein, the right side is a voltage of the control terminal WP of the memory 13 when V_{HPD} is used as a reference voltage.

When the +5 V power is not supplied from the +5 V power line 3, V_{HPD} is equal to at least the ground voltage, i.e., zero volt. Therefore, V_{HPD}=0 V can be set as a stringent condition. The write disable condition can hence be expressed as follows.
V_{IH}<(5−V_{F})×15a÷(15a+15b) (2)

As above, when the write disable condition is set to satisfy the condition of expression (2), the memory 13 is not set to the write enabled state even when the +5 V power is not supplied from the video signal source 1. In other words, when the condition of expression (2) is satisfied and if the +5 V power is supplied from the power source 11, the voltage of the control terminal WP of the memory 13 becomes a voltage of an H level equal to or more than V_{HPD}. This inhibits the writing operation in the memory 13 as can be seen from FIG. 2.

In a situation in which the power source of the display apparatus 2 is off and the +5 V power is not supplied from the power supply 11 and the +5 V power is fed from the DVD player 1, since the resistor 14a is sufficiently smaller in resistance than the resistors 15a and 15b, the control terminal WP of the memory 13 is at an “H” level and is not set to the write enabled state.

Therefore, by satisfying the conditions, even when the power (+5 V) of the memory 13 is supplied from either one of the power source 11 and the video signal source apparatus, the memory 13 is set to the read enabled state (write disabled state) in any cases. In this point, the embodiment differs from the related technique. That is, the memory does not enter the write enabled state even in the situation described above.

Next, description will be given of a write enable condition to allow a writing operation in the memory 13. Since the specification information of the display apparatus 2 is written in the memory 13 in this embodiment, a particular dedicated unit 17 as a memory writing jig is connected, in place of the DVD player 1 as a video signal source, to the display apparatus 2. The +5 V power line 3 is open and the HPD voltage satisfying expression (3) is supplied from the dedicated unit 17 to the HPD line 4.
V_{IL}>(5−V_{F}−V_{HPD})×15a÷(15a+15b)+V_{HPD} (3)
where, V_{HPD}<0 V.

As can be seen from FIG. 2, the control terminal WP of the memory 13 is at an “L” level equal to or less than V_{IL} for the write enabled state. Therefore, the memory 13 can be set to the write enabled state.

Operation of the embodiment will now be described.

In the configuration of FIG. 2, to read the specification information of the display apparatus 2 from the memory 13, the DVD player 1 applies a power voltage of +5 volt from the +5 V power line 3 to the display apparatus 2 to confirm whether or not the read enable signal (HPD) line 4 is at an “H” level. Assume that the input of the signal line 4 of the DVD player 1 is of high impedance. The +5 V voltage is fed via the power controller 12 to the memory 13, which then enters an operable state. At the same time, the +5 V voltage is also delivered from the +5 V power line 3 to the read enable signal generator 14. The signal generator 14 then outputs an H-level signal-(specifically, via the resistor 14a) to the read enable signal (HPD) line 4, and the H-level signal is delivered to the DVD player 1. The +5 V voltage is also fed from the power controller 12 via the erroneous rewriting inhibiting circuit 15 satisfying expression (2) as the write disabling condition to the memory 13. Resultantly, the +5 V voltage sets the control terminal WP thereof to an “H” level and the memory 13 to the write disabled state.

When it is confirmed that the voltage on the read enable signal (HPD) line 4 is at an H-level, the DVD player 1 can read the display information via the communication interface 5.

In the embodiment, when power is supplied from either one of the DVD player 1 and the +5 V power supply 11, an H-level signal is applied to the control terminal WP of the memory 13 and hence the memory is set to the write disabled state in an ordinary situation for the user to operate the display apparatus 2. Therefore, even if a write signal is sent by mistake from the DVD player 1 via the communication interface 5 to the memory 13, data is not rewritten in the memory 13.

On the other hand, in a production step of the display apparatus in a factory or in the maintenance of the display apparatus, when the dedicated unit 17 is connected, in place of the video signal source 1, to the write disable/enable control block 16 to write or to rewrite information in the memory 13, the memory 13 is powered by the +5 V power supply 11 and the +5 V power line 3 is open on the side of the dedicated unit 17 for the following reason. That is, when the +5 V power is supplied from the dedicated unit 17, the read enable signal generator 14 outputs an H-level signal to the read enable signal (HPD) line 4 and the H-level signal is delivered to the dedicated unit 17. This adversely influences the write enabling operation.

Subsequently, to set the voltage of the control terminal WP of the memory 13 to a value equal to or less than the maximum value of the write enable voltage, the dedicated unit 17 applies a negative voltage V_{HPD} satisfying the write enable condition of expression (3) to the read enable signal (HPD) line 4. As a result, the memory 13 enters the write enabled state, and hence the display specification information can be written from the dedicated unit 17 via the communication interface 5 in the memory 13.

According to the present invention, a predetermined voltage satisfying the write enable condition of the write disable/enable control terminal of the memory to store specification information of the display apparatus is applied by use of the read enable signal (HPD) line to the erroneous rewriting inhibiting circuit to thereby set the memory to the write enabled state.

Conditions represented by expressions (1) to (3) may also be changed depending on the circuit configuration of the constituent components such as the power control circuit 12 and the erroneous rewriting inhibiting circuit 15. In either cases, it is only required that the memory 13 is set to the write disabled state when power is supplied from the power supply 11 of the display apparatus 2 or the power source of the video signal source 1. It is also required that when a voltage is applied from the HPD terminal, the memory 13 enters the write enabled state.

### Second Embodiment

Next, description will be given of a second embodiment of the present invention. In the first embodiment, a voltage satisfying the write enabling condition for the write disable/enable control terminal of the memory is applied from the dedicated unit 17 to the read enable signal line (HPD line) 4. However, the present invention is not restricted only by the first embodiment. For example, in the configuration of FIG. 2, when the signal line (HPD line) 4 is set to an open state on the side of the dedicated unit 7 and a predetermined voltage similar to that described above is applied to the side of the +5 V power line 3, the memory can be set to the write enabled state for the following reason. That is, when the resistor 14a of the read enable signal generator 14 is sufficiently smaller in resistance than the resistors 15a and 15b included in the erroneous rewriting inhibiting circuit 15, the write enabling condition of expression (3) can be readily satisfied. This can be easily predicted by referring to FIG. 2 and hence it will be avoided to describe the operation in detail using drawings. In the operation, the signal line 4 is open on the side of the dedicated unit 7 to prevent an erroneous operation. That is, since the voltage is supplied from the dedicated unit 17 via the +5 V power line to the side of the display apparatus 2 in the embodiment, there exists a chance for the read enable signal generator 14 to conduct operation. In this case, when an H-level signal is delivered via the signal line 4 to the dedicated unit 17, there may occur such an erroneous operation. Therefore, when it is desired to establish the write enabled state in the embodiment, the signal line 4 is set to an open state to prevent the erroneous operation.

While the present invention has been described with reference to the particular illustrative embodiments, it is not to be restricted by those embodiments. the embodiments may be appropriately combined with each other. The display device 9 is not limited to a CRT display but may be, for example, a flat-type display such as a liquid-crystal display, a plasma display panel, or a field emission display (FED).

It should be further understood by those skilled in the art that although the foregoing description has been made on embodiments of the invention, the invention is not limited thereto and various changes and modifications may be made without departing from the spirit of the invention and the scope of the appended claims.

1. A display apparatus for displaying an image of video information from an external device, comprising:
a memory circuit storing information regarding the display apparatus;
a read enable unit allowing the external device to read information from the memory circuit;
a write disable unit inhibiting a write operation in the memory circuit when either one of a power supply of the display apparatus and a power supply of the external device turns on; and
a write enable unit allowing a write operation in the memory circuit in response to a signal from an external terminal used by the read enable unit.

2. A display apparatus according to claim 1, wherein the memory circuit includes a write control terminal for receiving allowance of a write operation from the write enable unit and inhibition of a write operation from the write disable unit.

3. A display apparatus according to claim 1, by use of an external device for transmitting a signal via the external terminal and by use of the write enable unit for the display apparatus, the memory circuit is set to a write enabled state in which a write operation is allowed in the memory circuit.

4. A display apparatus for displaying an image of video information from an external device, comprising:
a memory circuit storing information regarding the display apparatus;
a read enable unit allowing the external device to read information from the memory circuit; and
a write enable unit allowing a write operation in the memory circuit in response to a signal from an external terminal used by the read enable unit.

5. A display apparatus, comprising:
a storage unit storing information regarding the display apparatus;
an output unit outputting information stored in the storage unit to an external device; and
an external terminal transmitting a read enable signal to the external device for allowing the external device to read information from the storage unit and receiving a write enable signal for allowing the external device to conduct a write operation in the storage unit.

6. A display apparatus, comprising:
a storage unit storing information regarding the display apparatus; and
an output unit outputting information stored in the storage unit to an external device, wherein a write enable signal for allowing a write operation in the storage unit is received by use of an external terminal to which power is supplied.

7. A display apparatus according to claim 6, wherein the external terminal is a terminal connected to a terminal of a cable conforming to a high-definition digital multimedia interface (HDMI) or digital visual interface (DVI) standard.

8. A display apparatus for displaying an image of video information from an external device, comprising:
a memory circuit storing information regarding the display apparatus; and
a write disable unit inhibiting a write operation in the memory circuit when either one of a power supply of the display apparatus and a power supply of the external device turns on.
